(19) United States
(12) Patent Application Publication
(10) Pub. No.: US 2009/0287641 A1
(43) Pub. Date: Nov. 19, 2009

(54) METHOD AND SYSTEM FOR CRAWLING THE WORLD WIDE WEB

(76) Inventor: Eric Rahm, Boulder, CO (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/119,651

(22) Filed: May 13, 2008

(51) Int. Cl. G06F 17/30

(52) U.S. Cl. 707/3; 707/E17.108

(57) ABSTRACT

A method and system for crawling the World Wide Web is described. One embodiment avoids becoming bogged down by dynamically generated Uniform Resource Locators (URLs) pointing to Web pages having the same or substantially similar content (e.g., URLs generated by a “spam poison” Web site) by browsing automatically and systematically Web pages within a first domain of the World Wide Web, each Web page having its own content; determining that the content of a currently visited Web page is the same as that of a predetermined number of other Web pages that have already been visited; and ceasing to browse the first domain and instead browsing a second domain of the World Wide Web different from the first domain in response to determining that the content of the currently visited Web page is the same as that of a predetermined number of other Web pages that have already been visited.

### FIELD OF THE INVENTION

The present invention relates generally to Internet technology. In particular, but not by way of limitation, the present invention relates to methods and systems for crawling the World Wide Web.

### BACKGROUND OF THE INVENTION

Web crawlers, computer applications that automatically and systematically or methodically browse the World Wide Web (the “Web”), are used for a variety of purposes. For example, operators of Web search engines use Web crawlers to acquire up-to-date copies of Web content so that the content can be indexed for efficient searching. Web crawlers are also sometimes used to automate maintenance tasks on Web sites such as checking the validity of links or validating HyperText Markup Language (HTML) code. Makers of anti-malware software can also use Web crawlers to search the Web for Web sites that are potential sources of malware so that malware definitions can be created to aid in detecting the malware and removing it from infected computers. E-mail spammers also use Web crawlers to harvest target e-mail addresses from Web pages.

The problem sometimes arises that a Web server in a particular domain dynamically generates “dummy” Uniform Resource Locators (URLs) as the domain is being “crawled” for the purpose of bogging down or otherwise hindering the Web crawler. In such cases, the dynamically generated URLs (e.g., hyperlinks) may differ in the network path they specify, but the pages to which they point typically contain identical or very nearly identical content. When the Web crawler follows one URL, the server generates another URL such that the Web crawler can never exhaust all of the URLs in the domain, effectively trapping the Web crawler in that domain.

The above-described problem sometimes occurs, for example, with so-called “spam poison” Web sites, Web sites that are configured to trap the Web crawlers used by e-mail spammers to collect e-mail addresses of potential targets. Unfortunately, such Web sites can also hinder legitimate Web crawlers used for indexing Web pages or researching sources of malware for the purpose of creating malware definitions for anti-malware applications.

It is thus apparent that there is a need in the art for an improved method and system for crawling the Web.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

The present invention can provide a method and system for crawling the World Wide Web. One illustrative embodiment is a method, comprising browsing automatically and systematically a plurality of Web pages within a first domain of the World Wide Web, each Web page in the plurality of Web pages having its own content; determining that the content of a currently visited Web page in the plurality of Web pages is the same as that of a predetermined number of other Web pages in the plurality of Web pages that have already been visited; and ceasing to browse the first domain and instead browsing a second domain of the World Wide Web different from the first domain in response to determining that the content of the currently visited Web page in the plurality of Web pages is the same as that of a predetermined number of other Web pages in the plurality of Web pages that have already been visited.

Another illustrative embodiment is a system, comprising at least one processor; a communication interface with which to communicate with the World Wide Web; and a memory containing a plurality of program instructions configured to cause the at least one processor to browse automatically and systematically a plurality of Web pages within a first domain of the World Wide Web, each Web page in the plurality of Web pages having its own content; generate, for each visited Web page in the plurality of Web pages, an identifier based on the content of that Web page, visited Web pages with the same content having the same identifier, visited Web pages with different content having different identifiers; store the identifier of at least one Web page in the plurality of Web pages that has already been visited; compare the identifier of a currently visited Web page in the plurality of Web pages with the stored identifiers; and cease to browse the first domain and instead browse a second domain of the World Wide Web different from the first domain when the identifier of the currently visited Web page matches a predetermined number of the stored identifiers.

The invention may also be embodied at least in part as program instructions stored on a computer-readable storage medium, the program instructions causing a processor to carry out the methods of the invention.

These and other embodiments are described in further detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a functional block diagram of a computer equipped with a Web crawler application in accordance with an illustrative embodiment of the invention;

FIG. 2 is a flowchart of a method for crawling the World Wide Web (the “Web”) in accordance with an illustrative embodiment of the invention;

FIG. 3 is a flowchart of a method for crawling the Web in accordance with another illustrative embodiment of the invention;

FIG. 4 is a flowchart of a method for crawling the Web in accordance with yet another illustrative embodiment of the invention;

FIG. 5 is a diagram of a Document Object Model (DOM) of a Web page in accordance with an illustrative embodiment of the invention; and

FIG. 6 is a flowchart of a method for crawling the Web in accordance with yet another illustrative embodiment of the invention.

### DETAILED DESCRIPTION

In various illustrative embodiments of the invention, the problem of dynamically generated Uniform Resource Locators (URLs) that bog down a Web crawler within a particular domain is overcome by including in the Web crawler the capability of determining that a currently visited Web page has the same or very similar content as one or more Web pages that have already been visited. In response to such a determination, the Web crawler can take corrective action such as browsing to a different domain, thereby avoiding becoming trapped by, for example, a “spam poison” Web site.

Optionally, a Web crawler in accordance with an illustrative embodiment of the invention can also flag a domain in which “dummy” URLs are dynamically generated as a domain to be avoided during future Web crawling. After a predetermined period, the Web crawler may optionally return to the flagged domain to determine whether or not its character has changed since the last time it was crawled.

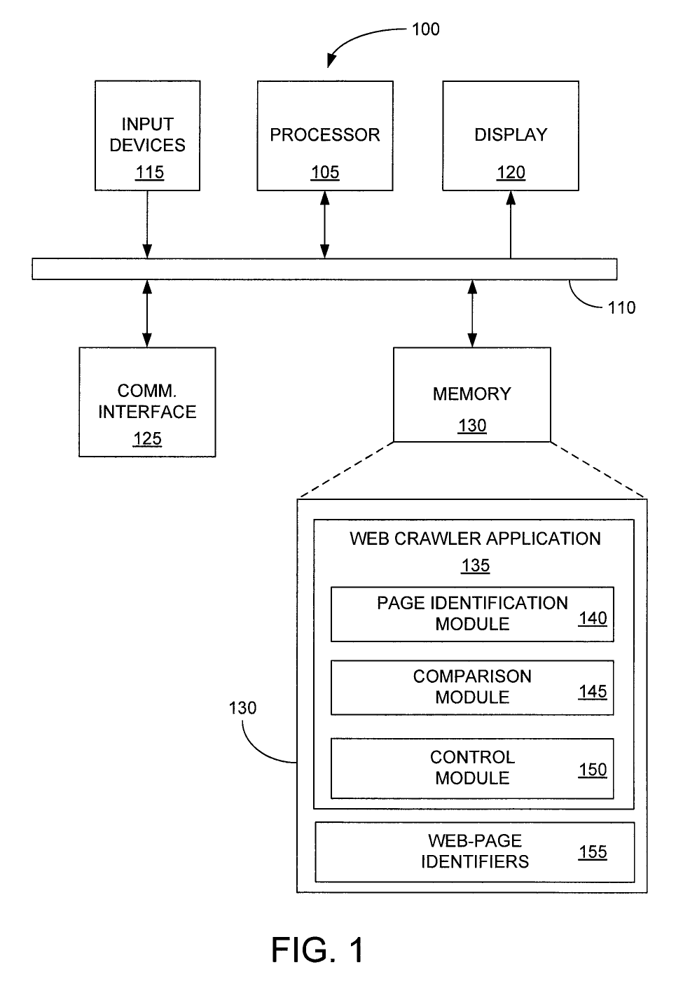

Referring now to the drawings, where like or similar elements are designated with identical reference numerals throughout the several views, and referring in particular to FIG. 1, it is a functional block diagram of a computer 100 equipped with a Web crawler application 135 in accordance with an illustrative embodiment of the invention. Computer 100 may be any computing device capable of running a Web crawler application 135. For example, computer 100 may be, without limitation, a personal computer (PC), a server, a workstation, a laptop computer, or a notebook computer.

In FIG. 1, processor 105 communicates over data bus 110 with input devices 115, display 120, communication interface 125, and memory 130. Though FIG. 1 shows only a single processor, multiple processors or a multi-core processor may be present in some embodiments.

Input devices 115 include, for example, a keyboard, a mouse or other pointing device, or other devices that are used to input data or commands to computer 100 to control its operation.

In the illustrative embodiment shown in FIG. 1, communication interface 125 is a Network Interface Card (NIC) that implements a standard such as IEEE 802.3 (often referred to as “Ethernet”) or IEEE 802.11 (a set of wireless standards). In general, communication interface 125 permits computer 100 to communicate with other computers via one or more networks. In particular, Communication interface 125 permits computer 100 to communicate as a client system with servers on the portion of the Internet known as the World Wide Web (the “Web”).

Memory 130 may include, without limitation, random access memory (RAM), read-only memory (ROM), flash memory, magnetic storage (e.g., a hard disk drive), optical storage, or a combination of these, depending on the particular embodiment. In FIG. 1, memory 130 includes Web crawler application (“Web crawler”) 135. Herein, “Web crawler” refers to a computer application or automated script that automatically and systematically browses the Web. Such automated Web browsing is typically performed within a given domain (e.g., “apple.com”) until all of the Web pages within that domain have been visited (browsed), after which the Web crawler moves on to a different domain and repeats the “crawling” process.

In the illustrative embodiment of FIG. 1, Web crawler application 135 includes the following functional modules: page identification module 140, comparison module 145, and control module 150. Web crawler 135 makes use of Web-page identifiers 155, which are also stored in memory 130. Their function is explained below. The division of Web crawler 135 into the particular functional modules shown in FIG. 1 is merely illustrative. In other embodiments, the functionality of these modules may be subdivided or combined in ways other than that indicated in FIG. 1, and the names of the various functional modules may also differ in other embodiments.

In one illustrative embodiment, Web crawler 135 and its functional modules shown in FIG. 1 are implemented as software that is executed by processor 105. Such software may be stored, prior to its being loaded into RAM for execution by processor 105, on any suitable computer-readable storage medium such as a hard disk drive, an optical disk, or a flash memory. In general, the functionality of Web crawler 135 may be implemented as software, firmware, hardware, or any combination or subcombination thereof.

Each Web page that Web crawler 135 visits has its own content (e.g., text, images, sound files, animations, Web applets, etc.). Page identification module 140 is configured to analyze a Web page to generate a Web-page identifier 155 (sometimes referred to herein as simply an “identifier”) that is unique for a given content. That is, for Web pages having identical content, page identification module 140 generates an identical identifier 155. Likewise, for Web pages having different content, page identification module 140 generates distinct identifiers 155. In some embodiments, page identification module 140 generates an identifier 155 for each Web page that Web crawler 135 visits. In other embodiments, the comparison of an identifier 155 for a visited Web page with those of previously-visited Web pages is contingent on the outcome of a preliminary test.

Page identification module 140 may employ any of a variety of techniques in generating Web-page identifiers 155. These include, without limitation, the use of hash functions, the extraction and compilation of tags used in the HyperText Markup Language (HTML) of the Web page, and the analysis of a Document Object Model (DOM) of the Web page. These techniques are described in greater detail below in connection with various illustrative embodiments of the invention.

Comparison module 145 compares an identifier 155 generated by page identification module 140 for a currently visited Web page with those stored in memory 130 for one or more already-visited Web pages. This provides a rapid and efficient way of comparing the content of the currently visited Web page with the content of previously visited Web pages (e.g., Web pages already visited within the same domain). In some embodiments, comparison module 145 is also configured to compare the overall structure of a currently visited Web page with that of already-visited Web pages whose respective overall structures are recorded in memory 130. Such a comparison may, for example, serve as a preliminary or “threshold” test such as that mentioned above in some embodiments. For example, if the overall structure of the currently visited Web page does not match that of any of the already-visited Web pages whose overall structures are stored in memory 130, there is no need to compare a content-based identifier 155 for the current page with those of previously-visited Web pages because the pages are clearly dissimilar. This approach can further improve the speed and efficiency of Web crawler 135. Illustrative techniques for inferring the overall structure of a Web page are discussed below.

Control module 150 controls the overall operation of Web crawler 135, including the manner in which page identification module 140 and comparison module 145 carry out their respective functions, depending on the particular embodiment or a particular mode of operation of a given embodiment.

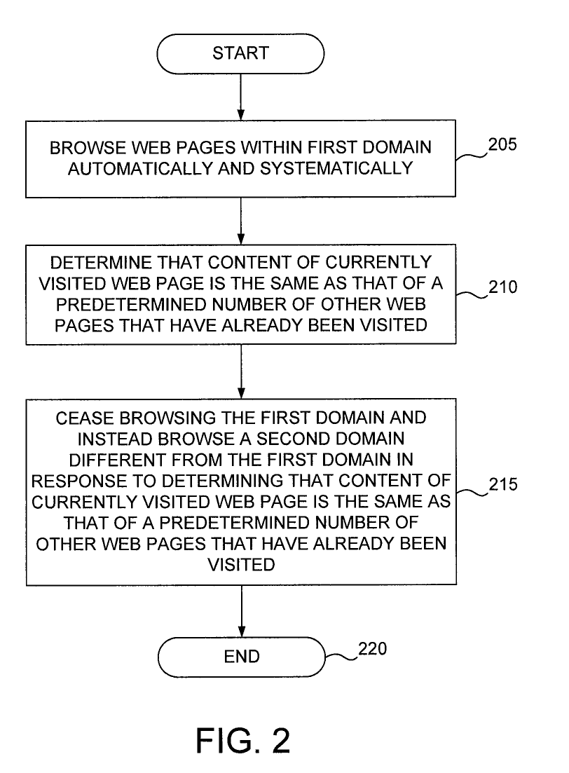

FIG. 2 is a flowchart of a method for crawling the Web in accordance with an illustrative embodiment of the invention. At 205, Web crawler 135 browses Web pages within a first (arbitrary) domain automatically and systematically. That is, Web crawler 135 “crawls” the first domain, as that term is typically used by those skilled in the art.

At 210, comparison module 145 determines, based on information obtained from page identification module 140, that the content of a currently visited Web page in the first domain is the same as that of a predetermined number of other Web pages in the first domain that have already been visited. The predetermined number just referred to may be as small as one, or it may be a significantly larger number (e.g., one million). The number of previously-visited Web pages against which the currently visited Web page is compared may be selected, depending on the particular application, to achieve a reasonable tradeoff among factors such as speed, memory usage, robustness, and complexity. In one illustrative embodiment, an identifier 155 for each of the last N Web pages visited is cached in memory 130, where N is chosen in accordance with the requirements of the particular application. Optionally, additional information such as the URL of each visited Web page may be cached along with its corresponding identifier 155.

At 215, control module 150 causes Web crawler 135 to cease browsing the first domain and to instead browse a second domain different from the first domain in response to the determination by comparison module 145 at 210 that the content of the currently visited Web page is the same as that of a predetermined number of other Web pages that have already been visited. That is, control module 150, in response to the findings of comparison module 145, ensures that Web crawler 135 does not get “trapped” in the first domain, where “dummy” URLs pointing to the same content are being generated dynamically (e.g., as on a “spam poison” site). In some embodiments, control module 150 takes into account whether the already-visited Web pages having the same content as the currently visited Web page were encountered recently or not. At 220, the method terminates.

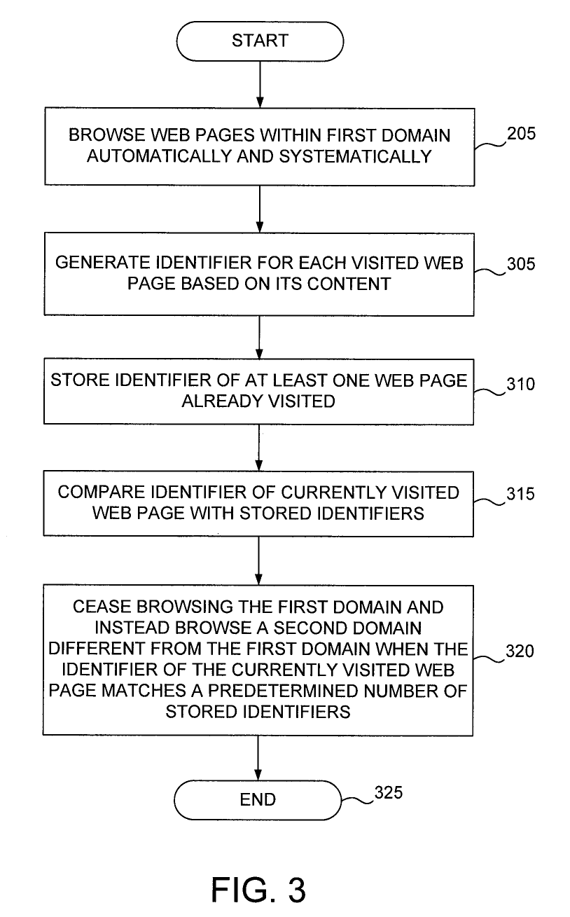

FIG. 3 is a flowchart of a method for crawling the Web in accordance with another illustrative embodiment of the invention. The method shown in FIG. 3, as in FIG. 2, commences with the crawling of a first domain (Block 205). At 305, page identification module 140 generates an identifier 155 for each Web page visited within the first domain based on the content of that Web page. As explained above, the identifier 155 is unique for a given content to enable rapid, efficient comparison of the content of Web pages.

In one illustrative embodiment, the identifier 155 of a visited Web page is generated by computing a hash function (e.g., MD5) of at least a portion of the content of the Web page. In some embodiments, a hash of the entire content of the Web page is computed. In other embodiments, portions of the content such as advertisements and images are excluded from the hash calculation. It has been observed that the Web pages to which the dynamically generated “dummy” URLs discussed above point often contain the same content except for objects such as advertisements or images. Excluding such objects from the hash calculation permits a more reliable comparison of the content of different Web pages.

In another illustrative embodiment, page identification module 140 generates the identifier 155 of a visited Web page by extracting and compiling a list of tags (e.g., HTML tags) used in the Web page. Such a list of tags can also act as a “fingerprint” of sorts that identifies the associated Web page.

In yet other embodiments, page identification module 140 generates the identifier 155 of a visited Web page by analyzing a DOM of the Web page. Embodiments employing analysis of a DOM are discussed in greater detail below.

At 310, the identifier 155 of at least one Web page already visited is stored in memory 130. As explained above, in some embodiments the identifiers 155 of the last N Web pages visited are cached in memory 130, where N is chosen in accordance with the particular requirements for Web crawler 135, depending on the application.

At 315, comparison module 145 compares the identifier 155 of a currently visited Web page with the stored identifiers 155 of Web pages already visited. At 320, control module 150 causes Web crawler 135 to cease browsing the first domain and to instead browse a second domain different from the first domain if the identifier 155 of the currently visited Web page matches a predetermined number of stored identifiers 155. As noted above, the predetermined number of identifiers required for taking such corrective action can be set in accordance with the requirements of the particular implementation. At 325, the method terminates.

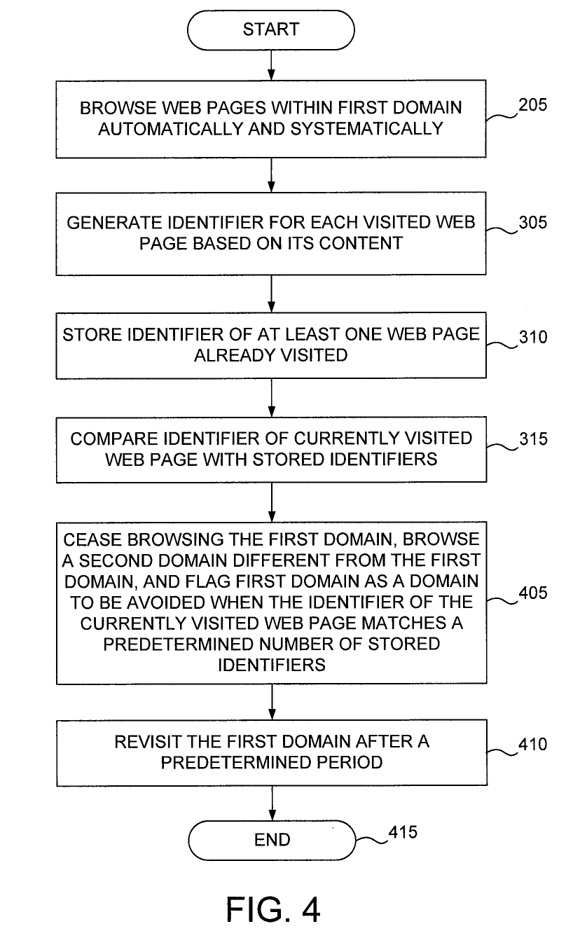

FIG. 4 is a flowchart of a method for crawling the Web in accordance with yet another illustrative embodiment of the invention. The method depicted in FIG. 4 is similar to that shown in FIG. 3 through Block 315. At 405, in addition to ceasing to browse the first domain and instead browsing a second domain different from the first domain in response to the comparison at 315, control module 150 flags the first domain as a domain to be avoided during future Web crawling by Web crawler 135.

At 410, control module 150 causes Web crawler 135 to revisit the first domain after a predetermined period has elapsed. Revisiting the first domain permits Web crawler 135 to determine whether the character of the first domain has changed since it was last crawled. If the first domain is no longer a source of dynamically generated URLs that can bog down a Web crawler, the first domain can be browsed like other “normal” domains, and the “avoid” flag can be removed. At 415, the method terminates.

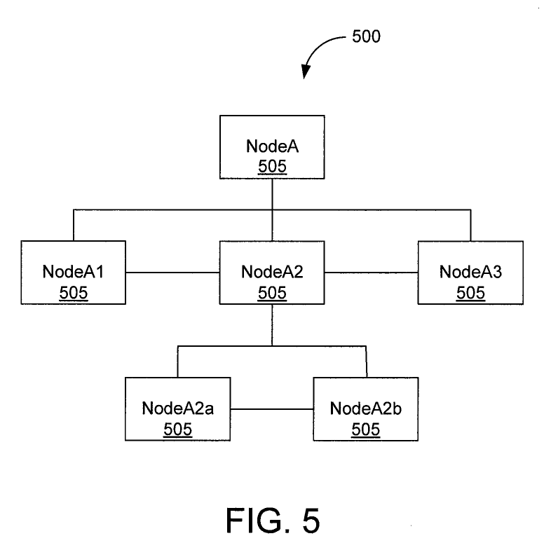

FIG. 5 is a diagram of a Document Object Model (DOM) 500 of a Web page in accordance with an illustrative embodiment of the invention. A DOM 500 is a platform- and language-independent standard object model for representing HTML, Extensible Markup Language (XML), or related formats. When a Web browser loads a Web page, it creates a hierarchical, tree-structured representation of its contents similar to the illustrative DOM shown in FIG. 5. As shown in FIG. 5, the hierarchical or “tree” structure of the DOM is made up of nodes 505. The DOM indicates how objects making up the Web page's content are nested and related.

In one illustrative embodiment, page identification module 140 begins at the “leaf nodes” (e.g., NodeA2a and NodeA2b in FIG. 5) and iteratively computes a hash value for the content on the Web page by traversing the DOM toward the root node (e.g., NodeA in FIG. 5). In this fashion, page identification module 140 can produce a single number that uniquely corresponds to a given content. In some embodiments, this is accomplished by combining separate hash values of the various nodes 505 into a single hash value for the overall Web page.

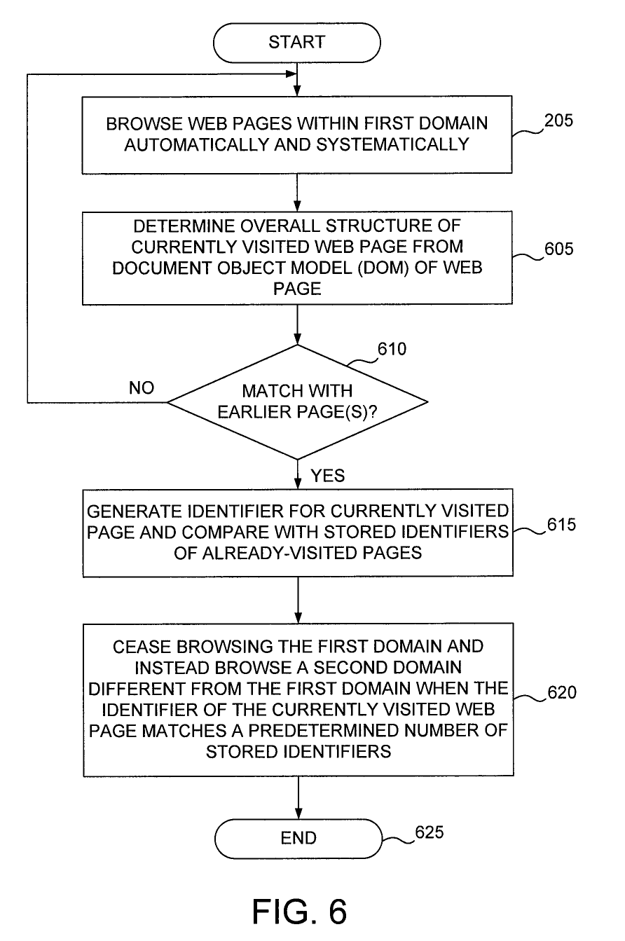

In other embodiments, Web crawler 135 analyzes a DOM of the visited Web pages to determine the overall structure of each page (e.g., the number of nodes in the DOM, the number of branches in the DOM, and the depth or height of each branch of the tree making up the DOM). Such an embodiment is described below in connection with FIG. 6.

FIG. 6 is a flowchart of a method for crawling the Web in accordance with yet another illustrative embodiment of the invention. The method commences as in the embodiment shown in FIG. 2 with the crawling of Web pages in a first domain (Block 205). At 605, page identification module 140 determines the overall structure of a currently visited Web page from a DOM of the Web page. At 610, comparison module 145 determines whether the overall structure of the currently visited Web page obtained at 605 matches that of one or more already-visited Web pages in the first domain. If not, Web crawler 135 continues crawling the first domain without comparing an identifier 155 for the currently visited Web page with those of already-visited Web pages.

Thus, the comparison of page structures at 610 serves as a high-level threshold test or “trigger” that determines whether the further step of comparing identifiers 155 is necessary. That is, if the structure of the currently visited Web page is unlike that of previously-visited Web pages in the first domain, the currently visited Web page can be ruled out as a page pointed to by a dynamically generated “dummy” URL, as described above. If, however, the overall structure of the currently visited Web page does match that of one or more previously-visited Web pages at 610, the currently visited Web page can be compared with previously visited Web pages more thoroughly using identifiers 155, as indicated in Blocks 615 and 620.

At 615, page identification module 140 generates an identifier 155 for the currently visited Web page in the first domain and compares the identifier 155 with the stored identifiers 155 of already-visited Web pages, as explained above. At 620, control module 150 causes Web crawler 135 to cease browsing the first domain and to instead browse a second domain different from the first domain if the identifier 155 of the currently visited Web page matches a predetermined number of stored identifiers associated with already-visited Web pages in the first domain. At 625, the method terminates.

Various embodiments of the invention can be deployed in a wide variety of applications. For example, a Web crawler 135 such as that described above can be used in indexing Web pages for a search engine. Such a Web crawler 135 can also be used in identifying Web sites that are potential sources of malware (e.g., viruses, Trojan horses, worms, keyloggers, spyware, etc.). In general, the principles of the invention can be applied to any Web crawler than can potentially become trapped or bogged down by dynamically generated “dummy” URLs that, despite having possibly different paths, point to Web pages containing the same or very similar content (e.g., a “spam poison” Web site).

In conclusion, the present invention provides, among other things, a method and system for crawling the Web. Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. Many variations, modifications, and alternative constructions fall within the scope and spirit of the disclosed invention as expressed in the claims.

What is claimed is:

1. A method for crawling the World Wide Web, the method comprising:
browsing automatically and systematically a plurality of Web pages within a first domain of the World Wide Web, each Web page in the plurality of Web pages having its own content;
generating, for each visited Web page in the plurality of Web pages, an identifier based on the content of that Web page, visited Web pages with the same content having the same identifier, visited Web pages with different content having different identifiers;
storing the identifier of at least one Web page in the plurality of Web pages that has already been visited;
comparing the identifier of a currently visited Web page in the plurality of Web pages with the stored identifiers; and
ceasing to browse the first domain and instead browsing a second domain of the World Wide Web different from the first domain when the identifier of the currently visited Web page matches a predetermined number of the stored identifiers.

2. The method of claim 1, further comprising:
flagging the first domain as a domain to be avoided when the identifier of the currently visited Web page matches the predetermined number of the stored identifiers.

3. The method of claim 2, further comprising:
revisiting the first domain after a predetermined period.

4. The method of claim 1, wherein generating, for each visited Web page in the plurality of Web pages, an identifier based on the content of that Web page includes computing a hash value of at least a portion of the content of the Web page.

5. The method of claim 4, wherein, in computing the hash value, at least one of images and advertisements on the Web page are excluded from the at least a portion of the content.

6. The method of claim 1, wherein generating, for each visited Web page in the plurality of Web pages, an identifier based on the content of that Web page includes compiling a list of tags used in the Web page.

7. The method of claim 1, wherein generating, for each visited Web page in the plurality of Web pages, an identifier based on the content of that Web page includes analyzing a Document Object Model (DOM) of the Web page.

8. The method of claim 7, wherein the analyzing includes traversing nodes in the DOM and iteratively computing a hash value of at least a portion of the content of the Web page.

9. The method of claim 1, further comprising:
determining for each visited Web page in the plurality of Web pages, prior to the generating, an overall structure of the Web page from a Document Object Model (DOM) of the Web page; and
comparing the overall structure of a currently visited Web page in the plurality of Web pages with that of one or more already-visited Web pages in the plurality of Web pages;
wherein comparing the identifier of the currently visited Web page with the stored identifiers is performed only when the overall structure of the currently visited Web page matches that of at least one already-visited Web page.

10. The method of claim 1, wherein browsing automatically and systematically a plurality of Web pages within the first domain of the World Wide Web and browsing the second domain of the World Wide Web are performed for the purpose of indexing Web sites.

11. The method of claim 1, wherein browsing automatically and systematically a plurality of Web pages within the first domain of the World Wide Web and browsing the second domain of the World Wide Web are performed for the purpose of identifying Web sites that are potential sources of malware.

12. The method of claim 1, wherein the first domain is one in which hyperlinks indicating different paths but pointing to respective Web pages having substantially identical content are generated dynamically by a server in the first domain while the plurality of Web pages in the first domain are being browsed automatically and systematically.

13. A method for crawling the World Wide Web, the method comprising:
browsing automatically and systematically a plurality of Web pages within a first domain of the World Wide Web, each Web page in the plurality of Web pages having its own content;
determining that the content of a currently visited Web page in the plurality of Web pages is the same as that of a predetermined number of other Web pages in the plurality of Web pages that have already been visited; and
ceasing to browse the first domain and instead browsing a second domain of the World Wide Web different from the first domain in response to determining that the content of the currently visited Web page in the plurality of Web pages is the same as that of a predetermined number of other Web pages in the plurality of Web pages that have already been visited.

14. A computer-readable storage medium containing a plurality of program instructions executable by a processor for crawling the World Wide Web, the plurality of program instructions comprising:
a first instruction segment configured to browse automatically and systematically a plurality of Web pages within a first domain of the World Wide Web, each Web page in the plurality of Web pages having its own content;
a second instruction segment configured to generate, for each visited Web page in the plurality of Web pages, an identifier based on the content of that Web page, visited Web pages with the same content having the same identifier, visited Web pages with different content having different identifiers;
a third instruction segment configured to store the identifier of at least one Web page in the plurality of Web pages that has already been visited;
a fourth instruction segment configured to compare the identifier of a currently visited Web page in the plurality of Web pages with the stored identifiers; and
a fifth instruction segment configured to cease browsing the first domain and instead browse a second domain of the World Wide Web different from the first domain when the identifier of the currently visited Web page matches a predetermined number of the stored identifiers.

15. The computer-readable storage medium of claim 14, wherein the plurality of program instructions further comprise:
a sixth instruction segment configured to flag the first domain as a domain to be avoided when the identifier of the currently visited Web page matches the predetermined number of the stored identifiers.

16. The computer-readable storage medium of claim 14, wherein the second instruction segment, in generating, for each visited Web page in the plurality of Web pages, an identifier based on the content of that Web page, is configured to compute a hash value of at least a portion of the content of the Web page.

17. The computer-readable storage medium of claim 14, wherein the second instruction segment, in generating, for each visited Web page in the plurality of Web pages, an identifier based on the content of that Web page, is configured to analyze a Document Object Model (DOM) of the Web page.

18. The computer-readable storage medium of claim 17, wherein the second instruction segment, in analyzing a DOM of the Web page, is configured to traverse nodes in the DOM and iteratively compute a hash value of at least a portion of the content of the Web page.

19. The computer-readable storage medium of claim 14, wherein the fourth instruction segment is configured to compare the identifier of the currently visited Web with the stored identifiers only when an overall structure of the currently visited Web page inferred from a Document Object Model (DOM) of the currently visited Web page matches that of at least one already-visited Web page.

20. A computer-readable storage medium containing a plurality of program instructions executable by a processor for crawling the World Wide Web, the plurality of program instructions comprising:
a first instruction segment configured to browse automatically and systematically a plurality of Web pages within a first domain of the World Wide Web, each Web page in the plurality of Web pages having its own content;
a second instruction segment configured to determine that the content of a currently visited Web page in the plurality of Web pages is the same as that of a predetermined number of other Web pages in the plurality of Web pages that have already been visited; and
a third instruction segment configured to cease browsing the first domain and instead browse a second domain of the World Wide Web different from the first domain in response to determining that the content of the currently visited Web page in the plurality of Web pages is the same as that of a predetermined number of other Web pages in the plurality of Web pages that have already been visited.

21. A system for crawling the World Wide Web, the system comprising:
at least one processor;
a communication interface with which to communicate with the World Wide Web; and
a memory containing a plurality of program instructions configured to cause the at least one processor to:
browse automatically and systematically a plurality of Web pages within a first domain of the World Wide Web, each Web page in the plurality of Web pages having its own content;
generate, for each visited Web page in the plurality of Web pages, an identifier based on the content of that Web page, visited Web pages with the same content having the same identifier, visited Web pages with different content having different identifiers;
store the identifier of at least one Web page in the plurality of Web pages that has already been visited;
compare the identifier of a currently visited Web page in the plurality of Web pages with the stored identifiers; and
cease to browse the first domain and instead browse a second domain of the World Wide Web different from the first domain when the identifier of the currently visited Web page matches a predetermined number of the stored identifiers.
